(19) United States
(12) Patent Application Publication
(10) Pub. No.: US 2014/0055739 A1
(43) Pub. Date: Feb. 27, 2014

(54) HIDDEN FLEX WITH AN OPEN END

(71) Applicant: Milan Kacavenda, Banja Luka (BA)

(72) Inventor: Milan Kacavenda, Banja Luka (BA)

(21) Appl. No.: 14/113,253

(22) PCT Filed: Apr. 18, 2012
(86) PCT No.: PCT/BA12/00007

§ 371 Date: Oct. 22, 2013

(30) Foreign Application Priority Data
Apr. 22, 2011 (BA) BAP112846A

(51) Int. Cl. G02C 5/22

(52) U.S. Cl. CPC G02C 5/2236
USPC 351/153

(57) ABSTRACT

The most practical production of this innovation is shown in pictures 11 and 12. The connective element (1) is pushed into the housing (54) executed in the temple (5), and then in the housing (111) at the open end of the connective element (1) we mount the spring (2) that is not tensioned, and then the screw (15) that goes through the spring (2). Both the screw (15) and the spring (2) are sized in such a way that they can move axially in the housing (111) of the connective element (1). The screw (15) goes through the narrowed part (12) of the housing (111), and at the same time the spring cannot go through the narrowed part (12). The screw (15) is screwed into the temple (5) with screwdriver passing through the housing (111) and it compresses the spring (2) by its head until it reaches closing delimiter. The connective element (1) mounted into the temple (5) in mis way, is then placed in the housing (4) of the frontal ending (6). The screw (61) is pushed through the hole (62), which goes through the hole (11) of the connective element (1).

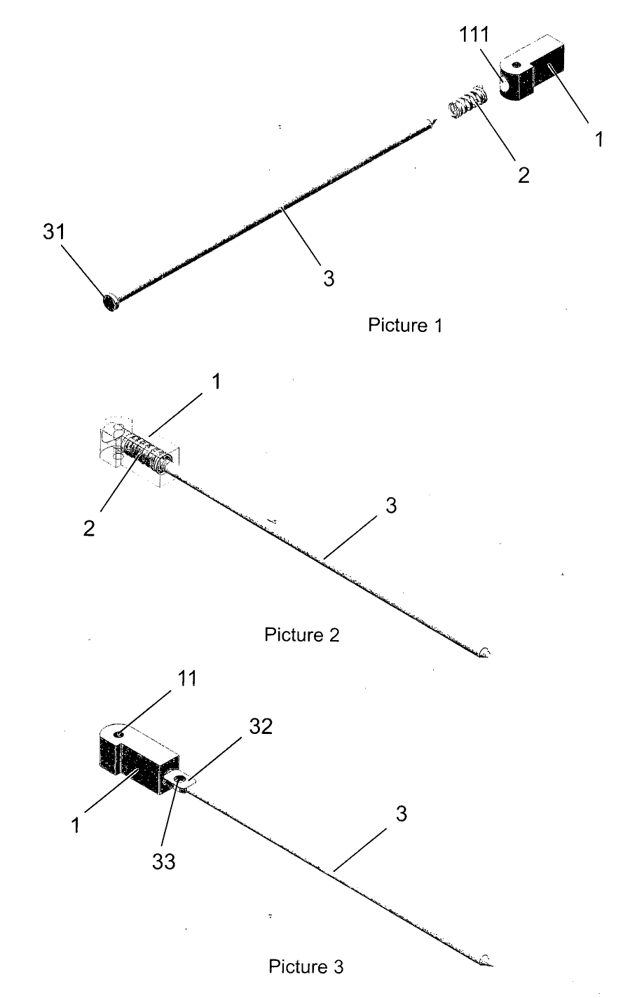

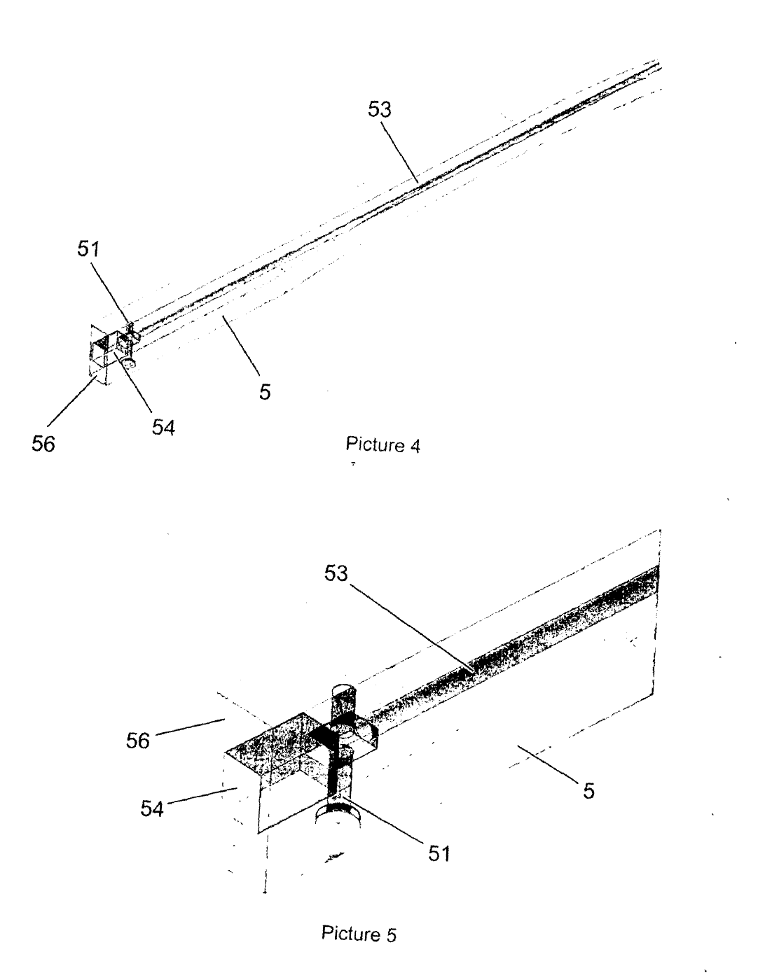

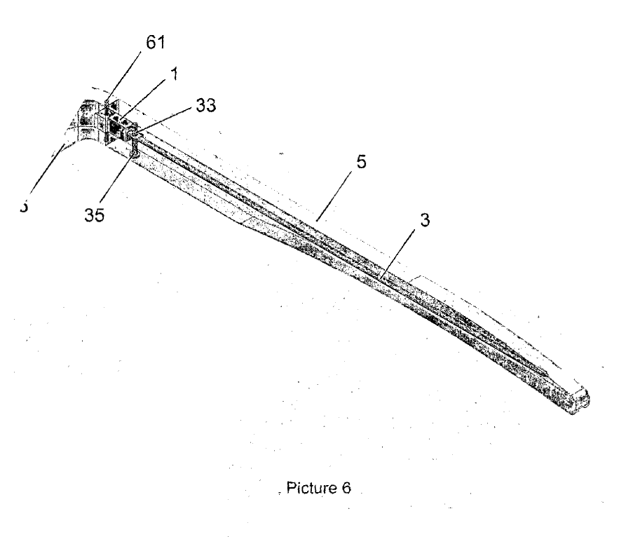

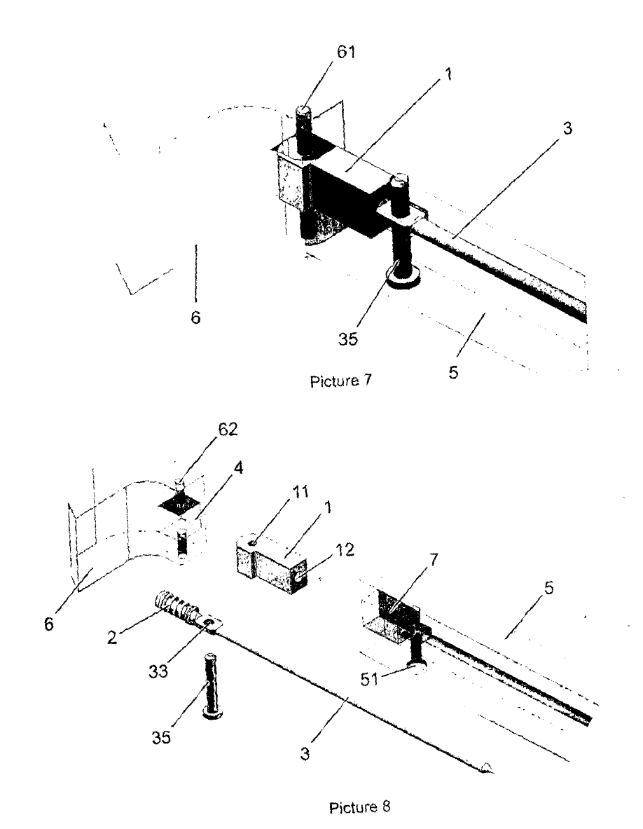

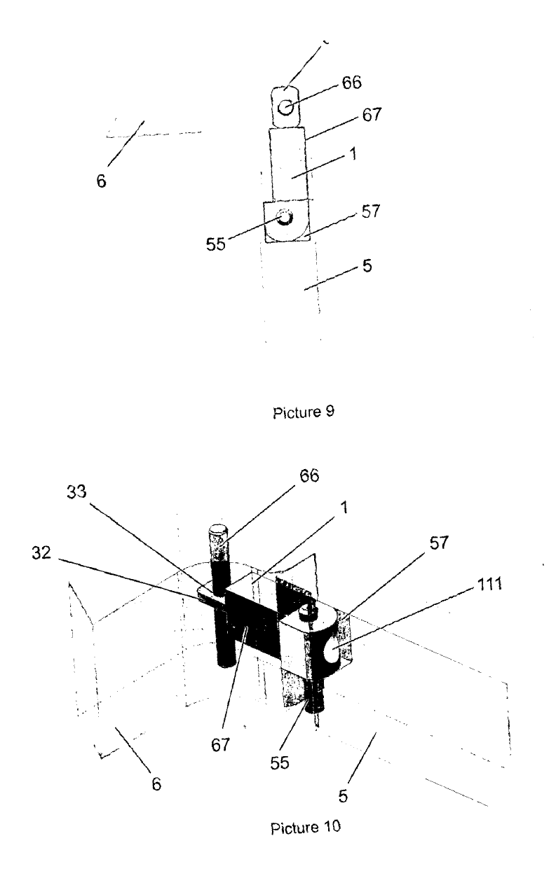

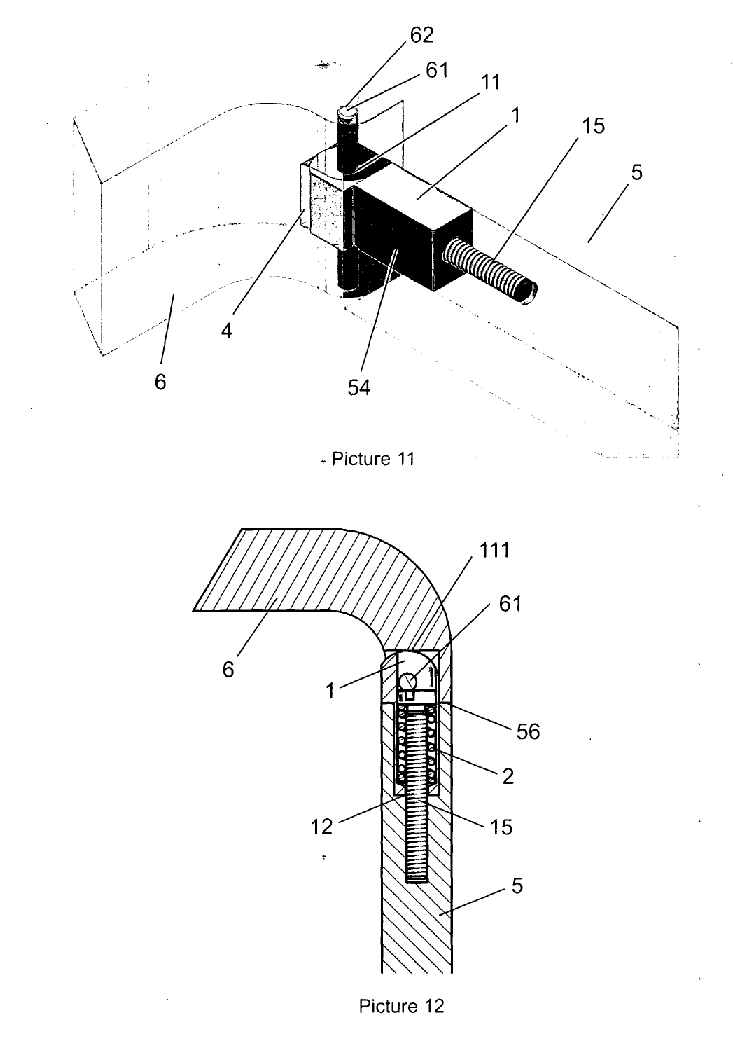

### 1) FIELD OF TECHNIQUE INVENTION REFERS TO

This invention refers to eyeglasses' flex, and according to international classification (IPC), it has been classified as: G02 C 5/22

### 2) CONDITION OF THE TECHNIQUE

The inventor is familiar with two hinge systems for glasses that are completely integrated into the temple and that have no parts which protrude from the frontal part. The first one is BL 2003 A 00011 owned by SKEYOTTICA, and the inventor is Kacavenda Milan, deposited in Italy. The system has two independent mechanisms with springs and the same rotation center. The flexes for eyeglasses are built into the eyeglasses temples in many ways depending on temple material. With plastic temples, the flex is being warmed up and melt into the plastic. With the materials that cannot be welded, the flex is welded directly onto the temple and after that the excess of the temple is being cut off in order to get exact distance between the flex's rotation center and frontal part of the temple. There were attempts to make housing in the temple material which corresponds to the form of the flex and then the flex id glued to the temple. Due to inefficiency of such manner and the need for build-in of flex onto the materials that cannot melt, nor weld, there is a need in the industry for our solution.

Various systems with tins were used, but were not accepted due to aesthetic reason, but also did not have needed strength if they the plastic temples of greater sizes and consequently greater weight had been mounted.

### 3) TECHNICAL ISSUE

Technical issue is to make such a hinge that would be mounted onto the metal carrier that spans along the whole length of the temple and is located inside the plastic temple, and that with this the processes of welding and melting of the metal carrier by melting plastic are avoided, and that in time there is no shortening of the plastic compared to metal carrier and protruding from the plastic. This is very common situation and the biggest flaw of the eyeglasses with plastic frames made using mechanical CNC processing, because the center of temple rotation is fixed to the metal carrier, and the delimiter of the temple opening is the front part of the plastic temple itself and it is clear that the change of opening delimiter length will cause change in opening angle, which in most cases leads to uselessness of the eyeglasses because they are too wide then. The next issue is to drastically cut down on costs in assembly phase which is one of the greater problems in the eyeglasses industry. Subsequent issue is to make a flex whose parts do not ask for application of expensive and complicated machines and whose price is significantly below all flexes known to us. The next issue is to avoid any kind of finishing in final assembly such as oiling, adjustment of irregular fitting of the temple onto the frontal part, adjustment of the temples in closed position, etc.

The next issue is to make eyeglasses with strong flex mechanism, such that the whole mechanism has no parts that protrude from the frontal part and from the temple. The next issue is to enable eyeglasses manufacturers that cannot weld or glue efficiently, to create such a flex so that all work comes down to material deduction, not adding like welding. The next issue is to avoid the need for heating any parts of the eyeglasses, because such flexes are inapplicable for many materials used for eyeglasses' manufacturing, such as carbon, titanium, magnesium . . .

Because of all the above and everything that comes out from the deeper analysis, the inventor of this flex set himself a task to create such a flex that will simultaneously eliminate all of the above mentioned disadvantages.

### 4) REPRESENTATION OF THE INVENTION ESSENCE

The essence of the invention is to execute housing in the temple that axially corresponds to the outer form of the outer element and in extension of the housing to the connective element, a hosing for the temple's metal carrier is executed. At the exactly set distance from the front part of the temple a hole is drilled into which a screw will be pushed in that will go through the hole made in the metal carrier as well. During the assembly phase of these two housings, an already coupled assembly is simply pushed, of the connective element and metal carrier with already stretched spring. The spring is stretched between the head, connective element and the ending of the hole in the connective element which contains the spring.

The spring has capability of elastic shrinkage to the extent the designer has determined. That motion would be working motion of the spring, to the maximum shrinkage and at the same time that would be the delimiter of temple opening. The assembly is pushed into the housing until the bump in the outer form of the connective element makes contact with the front part of the temple. In this position, both the hole in the temple and the hole in the metal carrier will match. The screw that goes through these holes serves to fix the whole mechanism with the temple. The other end of the mechanism that protrudes from the temple after the assembly into the temple, is pushed into the hosing in the frontal part. This housing is executed in already known manner by material extraction, so that it enables rotation of the connective element with the center of rotation in the center of the hole executed in this housing. The length of the hole in the connective element and tolerance between this hole and corresponding screw determine the possibility of the unwanted deviation along y-axis. The screw that connects the temple and the frontal part is pulled through the hole in the frontal part and then with light pressure gently pushed through the hole in the connective element which causes additional tensioning of the spring, measured in tenths of millimetre, and at the same time the front part of the temple and ending of the frontal part are brought into elastic contact. The position of the temple in relation to the frontal part depends on the shapes and angles of these surfaces. Every deviation of these surfaces caused by outer influence causes additional tensioning of the spring and the tendency of returning of the temple to the position where its spring is less tensioned.

### 5) SHORT DESCRIPTION OF THE SKETCH

Pic 1. Display of mechanism elements

Pic 2. Display of elements in the mechanism before pressing procedure

Pic 3. Display of mechanism after pressing procedure

Pic 4. Display of temple before assembly

Pic 5. Detailed display of front part of the temple

Pic 6. Display of temple and frontal part with belonging elements in folded position

Pic 7. Detailed display of temple and frontal part with belonging elements in folded position

Pic 8. Display of mechanism elements in explosion

Pic 9. View from above of mechanism elements at inverted positions

Pic 10. Detailed display of mechanism elements at inverted positions

Pic 11. Detailed display of mechanism elements in assembly with screw version

Pic 12. View from above of mechanism elements in assembly with screw version

### 6) DETAILED DESCRIPTION OF THE INVENTION

The most practical production of this innovation is shown in pictures 11 and 12. The connective element (1) is pushed into the housing (54) made in the temple (5) and then we mount the spring (2) that is not tensioned into housing (111) at the open end of the connective element (1), and then the screw (15) too which goes through the spring (2). Both the screw (15) and the spring (2) are sized in such a way that they can move axially in the housing (111) of the connective element (1). The screw (15) goes through the narrowed part (12) of the housing (111), and at the same time the spring cannot go through the narrowed part (12). The screw (15) is screwed into the temple (5) with screwdriver passing through the housing (111) and it compresses the spring (2) by its head until it reaches closing delimiter. The closing delimiter is an auxiliary part that is delivered by the Flex manufacturer and whose purpose is to serve the manufacturer to confidently tighten the spring (2) in precise, in advance determined distance between the screw head (15) and narrowed part of the housing (12). The delimiter of the screw is executed in such a way so that it can be inserted between the step (15) of the connective element (1) and front part (56) of the temple and then the screw (15) is screwed to the maximum movement. The thickness of the screwing delimiter is the same as the wanted movement of the spring, so it is clear that with the removal of the delimiter the spring (2) would have possibility of spreading equal to the thickness of the closing delimiter, and the removal is done after the assemble of the temple onto the frontal part (6).

The connective element (1) mounted into the temple (5) in this way, then, is placed in the housing (4) of the frontal ending (6). The screw (61) is pushed through the hole (62), which goes through the hole (11) of the connective element (1). In this phase, the front part of the temple (56) and front part of the frontal part are not in contact because the closing delimiter holds the spring (2) maximally compressed which keeps the temple (5) away from the hole (11) through which the connecting is done. After fixation of the screw (61), closing delimiter is removed and this activates the spring (2) that will push the screw head (15), with its spreading, towards the screw (61) and by that bring front part of the temple (56) and front part of the frontal part into elastic contact.

1. Hidden flex with an open end consists of the connective element (1) which is drilled on its one side and makes housing (111) into which a spring (2) is mounted and through the spring (2) either metal carrier (3) or a screw (15) passes through, which with its nubs (31), (151) compresses the spring between the ends (31), (151) and narrowed part (12) of the connective element (1), characterized in that the connective element (1) mounted into the temple (5) by screwing the screw (15) into the temple (5) with passing of the screwdriver of the spring (2) and screw (15) through the housing (111), at which time the screw (15) is screwed at, in advance determined, distance in relation to the hole (11) which provides compression of the spring (2) to the projected size.

2. Hidden flex with an open end consists of the connective element (1) which is drilled on its one side and makes housing (111) into which a spring (2) is mounted and through the spring (2) either metal carrier (3) or a screw (15) passes through, which with its nubs (31), (151) compresses the spring between the ends (31), (151) and narrowed part (12) of the connective element (1), characterized in that the connective element (1) mounted into the temple (5) by passing through and by fixing metal carrier (3) using screw (35) that goes through the housing (51) in the temple (5) and then through the hole (33) on the metal carrier (3) at which time the spring (2) is compressed onto the projected size before assembly of this phase of metal carrier (3) into the connective element (1) when the pressing is done and when a nub (32) forms in which the hole is executed (33).

3. Hidden flex with an open end of claim 1, wherein the connective element (1) mounted into the frontal part (6) in which the housing is executed (67) identical to housing (54) in the temple (5) with belonging hole and screw (66) that by passing through the hole (33) blocks the connective element (1), and that in the temple (5) housing is executed (57) identical to housing (4) in the frontal part (6), at which time the center of rotation of the temple (5) in the screw (55) center around which the temple (5) rotation is done, at which time the metal carrier (3) is cut off immediately after the nub (32) and hole (66), and in case that the screw (15) is used, it screws into the frontal part (6) under the same circumstances as when it screws into the temple (5).

4. Hidden flex with an open end of claim 2, wherein the connective element mounted into the frontal part in which the housing is executed identical to housing in the temple with belonging hole and screw that by passing through the hole blocks the connective element, and that in the temple housing is executed identical to housing in the frontal part, at which time the center of rotation of the temple in the screw center around which the temple rotation is done, at which time the metal carrier is cut off immediately after the nub and hole, and in case that the screw is used, it screws into the frontal part under the same circumstances as when it screws into the temple.
